(19) United States
(12) Patent Application Publication
(10) Pub. No.: US 2012/0162022 A1
(43) Pub. Date: Jun. 28, 2012

(54) MULTI-BAND ANTENNA

(75) Inventor: CHENG-FAN WEI, New Taipei (TW)

(73) Assignee: HON HAI PRECISION INDUSTRY CO., LTD., New Taipei (TW)

(21) Appl. No.: 13/335,949

(22) Filed: Dec. 23, 2011

(30) Foreign Application Priority Data
Dec. 23, 2010 (TW) 099145490

(51) Int. Cl. H01Q 9/04

(52) U.S. Cl. 343/700 MS

(57) ABSTRACT

A multi-band antenna includes a grounding element extending along a lengthwise direction to form a side edge, a first radiating element, a second radiating element and a feeding line. The first radiating element is separated from and unconnected to the grounding element and comprises a feeding portion perpendicular to and separated from the grounding element and a first and second radiating portion respectively extending from the feeding portion along two different directions, the first radiating element being used on a first higher frequency band. The second radiating element is located on one side of the first radiating portion. The second radiating element works on a second lower frequency band by coupled to the second radiating portion. The second radiating portion of the first radiating element is separated from the second radiating element and the grounding element to respectively form two slots.

### BACKGROUND OF THE INVENTION

1. Field of the Invention

The present invention relates generally to a multi-band antenna, and more particularly to a wide-band multi-band antenna.

2. Description of the Prior Art

For the development of the wireless transmitting technology, the terminal electrical devices with 3G model are used more and more. For these terminal devices need low profile, the antenna should be made the smaller the better and has poorer performance for the influence by the components around in the terminal device. Traditional Planar Inverted-F Antennas (PIFA) of Wireless Wide Area Network (WWAN) are always effected easily and perform weak efficiency, so that these antennas can not cover a wide frequency band.

Hence, in this art, an improved multi-band antenna to overcome the above-mentioned disadvantages of the prior art should be provided.

### BRIEF SUMMARY OF THE INVENTION

A primary object, therefore, of the present invention is to provide a low-profile antenna with an improved connecting element.

In order to implement the above object, the multi-band antenna comprises a grounding element extending along a lengthwise direction to form a side edge, a first radiating element, a second radiating element and a feeding line. The first radiating element is separated from and unconnected to the grounding element and comprises a feeding portion perpendicular to and separated from the grounding element and a first and second radiating portion respectively extending from the feeding portion along two different directions, the first radiating element being used on a first higher frequency band. The second radiating element is located on one side of the first radiating portion and comprises a first radiating piece upward extending from the first side edge of the grounding element in a direction perpendicular to the grounding element, and a second radiating piece extending from an end of the first radiating piece forward to the first radiating portion along a horizontal plane parallel to the grounding element. The second radiating element works on a second lower frequency band by coupled to the second radiating portion. The feeding line is used to transmit signals and comprises an inner conductor connected to the feeding portion and an outer conductor connected to the grounding element. The second radiating portion of the first radiating element is separated from the second radiating element and the grounding element to respectively form two slots.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view illustrating a multi-band antenna according to a preferred embodiment of the present invention;

FIG. 2 is an exploded, perspective view of FIG. 1;

FIG. 3 is an exploded, perspective view similar to FIG. 2, but viewed from another angle; and

FIG. 4 is a test chart recording for an antenna of the multi-band antenna of FIG. 1, showing Voltage Standing Wave Ratio (VSWR) as a function of Wireless Wide Area Network frequency.

### DETAILED DESCRIPTION OF THE INVENTION

Reference will now be made in detail to a preferred embodiment of the present invention.

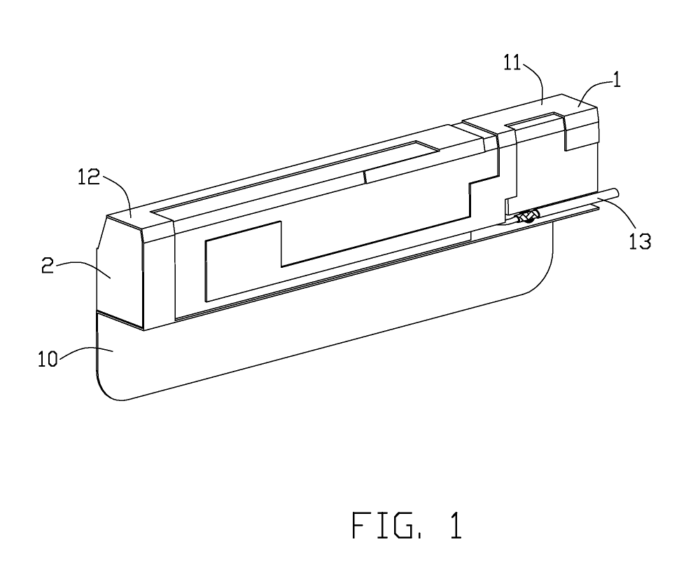

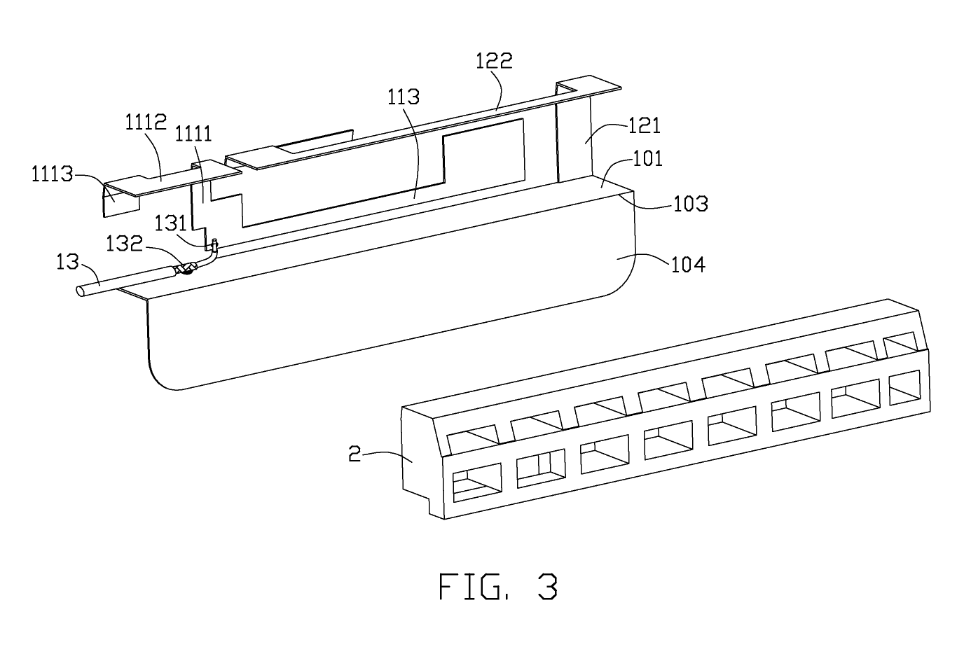

Reference to FIGS. 1 to 4, a multi-band antenna 1 is made by cutting a metal patch and comprises a grounding element 10, a first radiating element 11, a second radiating element 12 and a feeding line 13.

The grounding element 10 comprises a main portion 101 with a first side edge 102 and a second side edge 103, and a extending portion 104 downward extending from the second side edge 103.

The first radiating element 11 is separated from the grounding element 10 to form a first slot 16 and comprises a first radiating portion 111, a second radiating portion 113 and a feeding portion 112 connecting the first radiating portion 111 to the second radiating portion 113. The first radiating portion 111 and the second radiating portion 113 respectively extend from two opposite sides of the feeding portion 112 along two opposite directions. The first radiating portion 111 comprises a first side arm 1111 upward extending from the feeding portion 112 to be perpendicular to the grounding element 10, a U-shaped second side arm 1112 extending from the first side arm 1111 along a horizontal plane and parallel to the grounding element 10 to be perpendicular to the first side arm 1111, and a third side arm 1113 downward bending from the end of the second side arm 1112 to be perpendicular to the grounding element 10. The second radiating portion 113 is of L shape and comprises a narrower first piece 1131, and a wider second piece 1132 upward extending from the end of the first piece 1131 in a direction perpendicular to the first piece 1131.

The second radiating element 12 is substantially of L shape and located on one side of the first radiating portion 111 of the radiating element 11. The second radiating element 12 comprises a first radiating piece 121 upward extending from the first side edge 102 of the grounding element 10 in a direction perpendicular to the grounding element 10, a second radiating piece 122 extending from the end of the first radiating piece 121 forward to the first radiating portion 111 to form a lengthwise U shape, and a third radiating piece 123 downward extending from the end of the third radiating piece 123 away from the first radiating portion 111. The first radiating piece 121 extends along a horizontal plane parallel to the grounding element 10 and the third radiating piece 123 is of rectangular shape. The second radiating piece 122 and the second side arm 1112 of the first radiating element 11 are located on the same first plane. The least distance between the two radiating elements 11, 12 is located between the side end 1220 of the second radiating piece and the side beginning portion 11120 of the second side arm 1112 to form a second slot 14. The second radiating portion 113, the feeding portion 112 of the first radiating element 11 and the first radiating piece 121 of the second radiating element 12 are located on the same second plane. The second radiating portion 113 is located between the second radiating piece 122 of the second element 12 and the grounding element 10 from a side view. The second radiating piece 122 and the second side arm 112 are located on the same side of the feeding portion 112 and the second radiating portion 113 which two are located on the same plane. The sub least distance between the two radiating elements 11, 12 is located between an inner side of the first radiating piece 121 and the side end 1130 of the second radiating portion 113 to form a third slot 15.

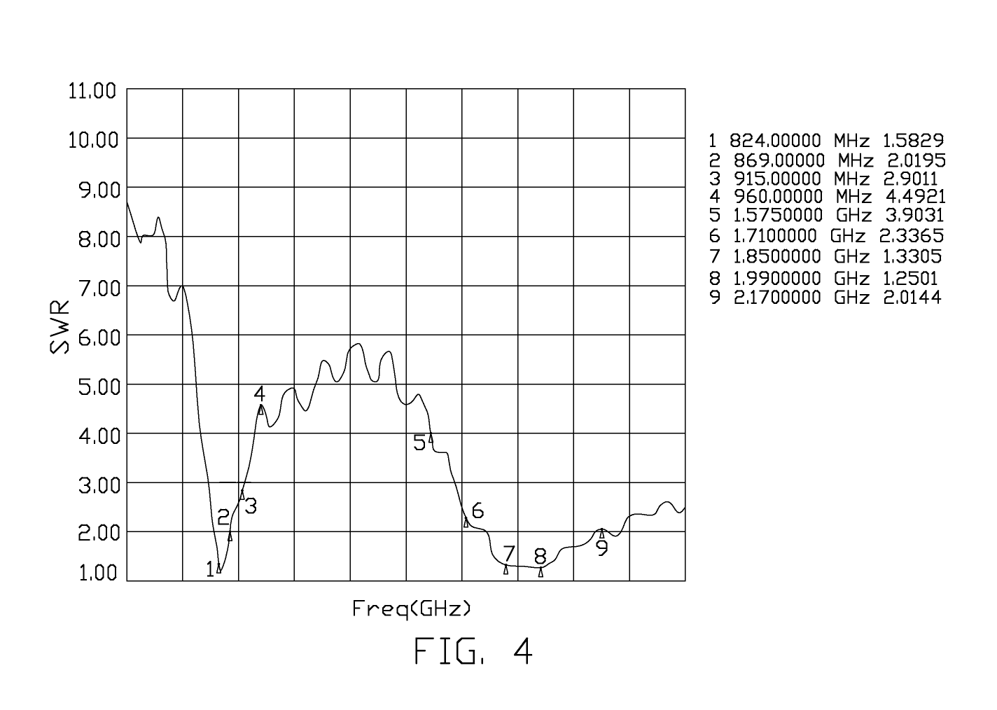

The feeding line 13 comprises an inner conductor 131 and an outer conductor 132. The inner conductor 131 is electrically connected to the feeding portion 112 and the outer conductor 132 is electrically connected to the grounding element 10. Referencing to FIG. 4, the first radiating portion 111 of the first radiating element 11 is operated on a higher first frequency band on 1.71-2.17 GHz which can be fit for being used in Distributed Control System (DCS, 1710-1880 MHz) network, Personal Communications Service (PCS, 1850-1990 MHz) network, and Universal Mobile Telecommunications System (UMTS, 1920-2170 MHz) network. The second radiating element 12 couples to the second radiating portion 113 of the first radiating element 11 to work on a lower second frequency band on 824-960 MHz which can be fit for being used in Advanced Mobile Phone Service (AMPS, 824-894 MHz) network and Global System for Mobile Communications (GSM, 880-960 MHz) network. The second radiating portion 113 is also used to match the impedance of the multi-band antenna to regulate the frequency bands of the first and second frequency bands.

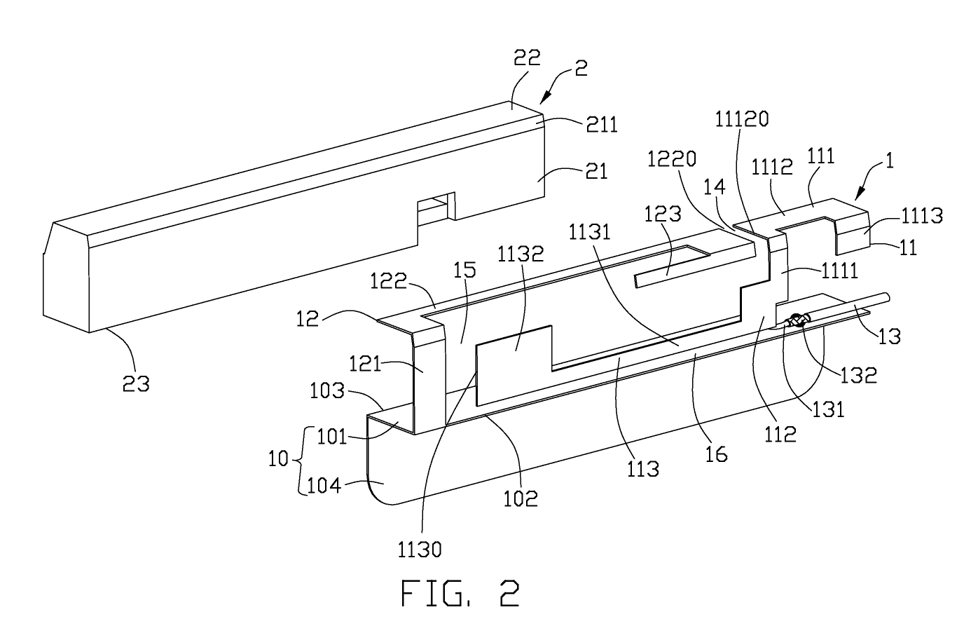

The multi-band antenna 1 is assembled on an erose insulation base portion 2, the base portion 2 is designed to cooperate to the multi-band antenna 1 to support the multi-band antenna 1. The base portion 2 comprises a front surface 21, a top surface 22 and a bottom surface 23. The multi-band antenna 1 surrounds the base portion 2 with the main portion 101 of the grounding element 10 attached on the bottom surface 23, the first radiating element 11 disconnected to the grounding element 10 and supported by the front surface 21 and the top surface 22 of the base portion 2, and the second radiating element 12 attached on the front surface 21 and the top surface 22 of the base portion 2. The first radiating element 11 has a horizontal portion on the top thereof attached on the top surface 22 of the base portion, and the same with a horizontal portion of the second radiating element 12. The first radiating element 11 and the second radiating element 12 respectively have a vertical portion attached on the front surface 21 of the base portion 2. In this embodiment, reference to FIG. 2, the base portion 2 has a slantwise plane. And the first radiating piece 121, the second radiating piece 123, the first side arm 1111, and the third side arm 1113 respectively have a slantwise plane (not labeled). Each of the different slantwise planes are respectively attached on different positions of the base portion 2. In other embodiments, the slantwise plane of the base portion 2 and the multi-band antenna 1 can be canceled, the extending portion 104 of the grounding element 10 can be made of a metal foil or be cancel, and the second radiating portion can be designed to form other structure.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multi-band antenna, comprising:
a grounding element, extending along a lengthwise direction to form a side edge;
a first radiating element separated from and unconnected to the grounding element, and comprising a feeding portion perpendicular to and separated from the grounding element and a first and second radiating portion respectively extending from the feeding portion along two different directions, the first radiating element being used on a first higher frequency band;
a second radiating element located on one side of the first radiating portion, and comprising a first radiating piece upward extending from the first side edge of the grounding element in a direction perpendicular to the grounding element, a second radiating piece extending from an end of the first radiating piece forward to the first radiating portion along a horizontal plane parallel to the grounding element, said second radiating element working on a second lower frequency band by coupled to the second radiating portion;
a feeding line used to transmit signals and comprising an inner conductor connected to the feeding portion and an outer conductor connected to the grounding element; wherein
said second radiating portion of the first radiating element is separated from the second radiating element and the grounding element to respectively form two slots.

2. The multi-band antenna as claimed in claim 1, wherein said the first radiating portion comprises a first side arm upward extending from the feeding portion to be perpendicular to the grounding element, a U-shaped second side arm extending from the first side arm along a horizontal plane and parallel to the grounding element to be perpendicular to the first side arm, and a third side arm downward bending from the end of the second side arm to be perpendicular to the grounding element.

3. The multi-band antenna as claimed in claim 2, wherein said second radiating portion is of L shape and comprises a narrower first piece, and a wider second piece upward extending from the end of the first piece in a direction perpendicular to the first piece.

4. The multi-band antenna as claimed in claim 3, wherein said first radiating piece is of U-shape configuration and the first radiating piece and the second side arm of the first radiating element are located on the same first plane.

5. The multi-band antenna as claimed in claim 4, wherein said second radiating element further comprises a third radiating piece downward extending from the end of the third radiating piece away from the first radiating portion.

6. The multi-band antenna as claimed in claim 5, wherein said a least distance between the two radiating elements is located between the side end of the second radiating piece and the side beginning portion of the second side arm to form a second slot.

7. The multi-band antenna as claimed in claim 5, wherein the second radiating portion, the feeding portion of the first radiating element and the first radiating piece of the second radiating element are located on the same second plane.

8. The multi-band antenna as claimed in claim 5, wherein said the second radiating portion is located between the second radiating piece of the second element and the grounding element from a side view.

9. The multi-band antenna as claimed in claim 5, wherein The second radiating piece and the second side arm are located on the same side of the feeding portion and the second radiating portion which two are located on the same plane.

10. The multi-band antenna as claimed in claim 5, wherein a sub least distance between the two radiating elements is located between an inner side of the first radiating piece and the side end of the second radiating portion to form a third slot.

11. The multi-band antenna as claimed in claim 1, further comprises a base portion designed to cooperate to the multi-band antenna to support the multi-band antenna.

12. The multi-band antenna as claimed in claim 1, wherein said first frequency band is on 1.71-2.17 GHz and the second frequency band is on 824-960 MHz.

13. A multi-band antenna, comprising:
a grounding element, extending along a lengthwise direction;
a first radiating element separated from the grounding element and supported by an insulation base portion, the first radiating element comprising a feeding portion and a first radiating portion and a second radiating portion respectively located on the two sides of the feeding portion and two different planes;
a second radiating element separated from the first radiating element and comprises a first radiating piece extending from the grounding element in a direction perpendicular to the grounding element and located the same plane with the second radiating portion of the first radiating element, a second radiating piece extending from the first radiating piece toward the first radiating portion, and a third radiating piece bended from the second radiating portion along a direction away from the first radiating portion;
a feeding line used to transmit signals and comprises an inner conductor connected to the feeding portion, an outer conductor connected to the grounding element; wherein
the first radiating portion of the first radiating element comprises a horizontal portion located on a plane the same as a plane the second radiating piece of the second radiating element located on and a tail portion extending from the horizontal portion.

14. The multi-band antenna as claimed in claim 13, wherein the base portion is designed to an erose structure to cooperate to the multi-band antenna.

15. The multi-band antenna as claimed in claim 14, wherein the base portion comprises a front surface, a top surface and a bottom surface, the multi-band antenna surrounds the base portion with a main portion of the grounding element attached on the bottom surface, the first radiating element disconnected to the grounding element and supported by the front surface and the top surface of the base portion, and the second radiating element attached on the front surface and the top surface of the base portion.

16. The multi-band antenna as claimed in claim 15, wherein the horizontal portion of the first radiating element is attached on the top surface of the base portion, and the same with a horizontal portion of the second radiating element, the first radiating element and the second radiating element respectively have a vertical portion attached on the front surface of the base portion.

17. A multi-band antenna comprising:
a grounding element including a horizontal portion extending along a lengthwise direction;
an insulator seated upon the horizontal portion;
a first radiating element and a second radiating element both supportably seated upon the insulator while being discrete from each other,
said first radiating element being separate from the grounding element with opposite first and second radiating portions with therebetween a middle feeding portion where an inner conductor of a feeding cable is mechanically and electrically connected;
said second element being connected to the grounding element at a position around one lengthwise end of said horizontal portion while said feeding cable extends into the antenna around the other lengthwise end.

18. The multi-band antenna as claimed in claim 17, wherein the insulator defines a recess in a bottom portion to receive the feeding cable therein.

19. The multi-band antenna as claimed in claim 17, where the first radiating element defines an S like configuration while the second radiating element defines an L like configuration.

20. The multi-band antenna as claimed in claim 19, wherein the insulator defines a vertical plane seated upon a side face of the insulator and adjacent to the grounding element, and a horizontal plane seated upon a top face of the insulator, and wherein the vertical plane is primarily occupied by the first radiating element while the horizontal plane is primary occupied by the second radiating element.
